(19) United States
(12) Patent Application Publication
(10) Pub. No.: US 2025/0330938 A1
(43) Pub. Date: Oct. 23, 2025

(54) METHOD AND APPARATUS FOR HANDLING UNAVAILABILITY OF UE IN WIRELESS NETWORK

(71) Applicant: SAMSUNG ELECTRONICS CO., LTD., Suwon-si, Gyeonggi-do (KR)

(72) Inventors: Lalith KUMAR, Bangalore (IN); Mahmoud WATFA, Bangalore (IN)

(21) Appl. No.: 18/872,089

(22) PCT Filed: Jun. 5, 2023
(86) PCT No.: PCT/KR2023/007671

§ 371 Date: Dec. 5, 2024

(30) Foreign Application Priority Data
Jun. 7, 2022 (IN) 202241032473
May 11, 2023 (IN) 202241032473

(51) Int. Cl. H04W 60/06; H04L 43/0805; H04W 60/04

(52) U.S. Cl. CPC H04W 60/06; H04L 43/0805; H04W 60/04

(57) ABSTRACT

The disclosure relates to a 5G or 6G communication system for supporting a higher data transmission rate. Embodiments herein provide a method for handling unavailability of UE in wireless network by UE. The method includes detecting an unavailability event that makes the UE unavailable to a network apparatus for a period. Further, the method includes determining an unavailability duration indicating a length of the period. Further, the method includes transmitting a deregistration request message to the network apparatus, wherein information on the unavailability duration is included in the deregistration request message and a deregistration type is set to a normal deregistration in the deregistration message. Further, the method includes initiating a timer to receive a deregistration accept message from the network apparatus.

### TECHNICAL FIELD

The present disclosure relates to a wireless network, and more particularly to a method and a system for handling unavailability of a User Equipment (UE) in the wireless network.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

In order to execute certain events, for example operating system (OS) upgrade, silent reset at a modem side or a modem application updates (also commonly called as binary updates) at a UE, there are three parties involved such as the UE, an operator and an application function (AF) apparatus. Once the UE has downloaded the binary updates, the binary upgrades are left for the UE implementation when the UE itself performs the upgrade. As the UE becomes unavailable without prior knowledge from a core network and/or the AF apparatus, the critical operations of the AF apparatus may be impacted when the critical operations depends on availability of the UE during an unavailability period (i.e. a period of time during which the UE is not available).

For the period/duration, the UE becomes unavailable is called as a “unavailability period”. For example, the events when UE becomes unavailable are listed below, also called as unavailability events hereafter:
a) Silent reset at the modem;
b) Security patch updates;
c) OS upgrade;
d) Modem software updates;
e) Device reboot upon modem setting changes via an Open Mobile Alliance device management (OMA-DM).
f) Discontinuous coverage of the UEs for e.g. when the UE is in a satellite access or when the UE is about to enter a discontinuous coverage.
g) The UE with analytic information or some learning model knows the UE enters into no service area or a limited service area.

Consider an example, a first UE and a second UE have received the binary updates. The first UE and the second UE has decided to perform an upgrade procedure. The first UE and the second UE decide to perform an upgrade operation at 12 AM in the night. The first UE and the second UE start upgrade procedure at 12 AM in the night and but the first UE and the second UE become unavailable to a network apparatus. At 12:01 AM, an event occurs due to which the first UE is required to gather some data in a first UE environment. Thus, the AF apparatus is trying to reach the first UE. But, the first UE is unavailable. Further, the AF apparatus tries to reach the second UE, the second UE is also not available. The AF apparatus is wondering why both the first UE and second UE are not reachable and AF apparatus is not aware how long both the UEs are not available. To solve such issues in the prior art, before UE becomes unavailable due to the example events listed above UE will indicate the determined unavailability period to the AMF and to the AF apparatus (through 5GS). But there are some limitations in this approach as discussed in FIG. 1.

FIG. 1 is a sequence diagram illustrating problem in the prior arts. The UE (100) become unavailable due to unavailability events, certain unavailability events for e.g. OS upgrade will need the UE (100) to become power off, thus as per prior art procedure, the UE (100) will indicate the power off as part of deregistration request message to the network apparatus, when a power off procedure is executed. The network apparatus can be, for example, but not limited to an Access & Mobility Management Function (AMF) apparatus (200) and a Network Exposure Function (NEF) apparatus. In this case, the network apparatus is the AMF apparatus (200). The UE (100) triggers a deregistration procedure with an indication that the UE (100) is powering OFF (also called as switch off). The network apparatus receives the indication and the network apparatus deregisters the UE (100) and the procedure is ended. When the UE (100) fails to send a deregistration message due to lower layer failure, transmission failure or any other reasons as specified in a 3^{rd} Generation Partnership Project Technical specification (3GPP TS) 24.501, the UE (100) locally deregisters. The UE (100) waits for maximum 5 seconds to send the deregistration message. If the deregistration message is not able to send to network apparatus, the UE (100) deregisters with the network apparatus.

The conventional procedure is OK because the UE (100) is powering off and there is no critical impact on a network side. But, when the UE (100) attempts to send unavailability period to the network apparatus, the unavailability period needs to be further forwarded to an Application server (also called as an AF apparatus (300)). Based on the unavailability period information, the AF apparatus (300) schedules another UEs to take up the role of the current UE which is going unavailable or perform some actions due to which the AF apparatus (300) are not impacted. The AMF may need to adjust its timers based on the unavailability period of the UE (100). Thus, in this particular case of power off the UE (100) should make sure that the deregistration procedure is successfully executed so that unavailability period reaches the network apparatus and further to the AF apparatus (300), thus there is a need for changes in the switch off procedure.

Referring to FIG. 1, at step 1, an Application Protocol (AP) entity (150) in the UE (100) sends an unavailability period to a Non-access stratum (NAS)/Access stratum (AS) entity (160) in the UE (100). At step 2, the NAS/AS entity (160) in the UE (100) initiates the deregistration procedure with switch off indication including the unavailability period to send it to the AMF apparatus (200). At step 3, the unavailability period is not delivered to the AMF apparatus (200) and the AF apparatus (300). But, the UE (100) becomes unavailable. At step 4, the critical application service is impacted because the AF apparatus (300) is not aware about the unavailability period and the services are impacted.

### DISCLOSURE OF INVENTION

### Technical Problem

The purpose of this application is to be able to solve at least one of the drawbacks of the prior art.

According to the prior art, a network does not know when UE becomes unavailable to the network in case of unavailability event.

There is a need for co-ordination between UE and network or between UE and application function on UE's unavailability and a period for unavailability.

### Solution to Problem

According to at least one embodiment of the disclosure, a method performed by a UE in a wireless network is provided. The method includes detecting an unavailability event that makes the UE unavailable to a network apparatus for a period; determining an unavailability duration indicating a length of the period; transmitting a deregistration request message to the network apparatus, wherein information on the unavailability duration is included in the deregistration request message and a deregistration type is set to a normal deregistration in the deregistration request message; and initiating a timer to receive a deregistration accept message from the network apparatus

According to at least one embodiment of the disclosure, a method performed by a network apparatus in a wireless network is provided. The method includes receiving, from a user equipment (UE), a deregistration request message including information on an unavailability period duration and a deregistration type set to a normal deregistration; and transmitting, to the UE, one of a deregistration accept message or a deregistration reject message based on the deregistration type.

According to at least one embodiment of the disclosure, a UE in a wireless network is provided. The UE includes a memory, a processor and a controller communicatively coupled to the memory and the processor and configured to detect an unavailability event that makes the UE unavailable to a network apparatus for a period, determine an unavailability duration indicating a length of the period, transmit a deregistration request message to the network apparatus, wherein information on the unavailability duration is included in the deregistration request message and a deregistration type is set to a normal deregistration in the deregistration message, and initiate a timer to receive a deregistration accept message from the network apparatus.

According to at least one embodiment of the disclosure, a network apparatus in a wireless network is provided. The network apparatus includes a memory, a processor and a controller communicatively coupled to the memory and the processor and configured to receive, from a user equipment (UE), a deregistration request message including information on an unavailability period duration and a deregistration type set to a normal deregistration, and transmit one of a deregistration accept message or a deregistration reject message based on the deregistration type.

### Advantageous Effects of Invention

The principal object of the embodiments herein is to provide a method and a system for handling unavailability of a UE in a wireless network. Whenever an event is triggered in the UE which makes that the UE is unavailable, the UE sets unavailability period in a deregistration request message and even though the UE switches OFF due to the event, the UE does not indicate a switch off cause in the deregistration request message, rather the UE sets a deregistration type to a normal deregistration (i.e. the Deregistration type IE does not indicate “switch off”.). The UE starts a timer T3521 and waits for the network apparatus to send a deregistration accept message. Once the deregistration accept message is received, the UE assumes that an unavailability period is set successfully in the network apparatus/AF apparatus. Further, a NAS entity in the UE indicates the same to upper layers (i.e., AP entity) about the same. Further, when the network apparatus receives the deregistration request message with a deregistration type set to the normal deregistration, the network apparatus send the deregistration accept message to the UE.

Another object of the embodiments herein is to provide that when the UE is not receiving the deregistration accept message and a T3521 timer expires at the UE, the UE re-attempts to send the deregistration request message with unavailability period, after 5 attempts (for example). Further, the UE aborts the deregistration procedure and indicates the same to the upper layer (i.e. AP entity). The upper layers selects to postpone executing the event because the unavailability period is not set at the network apparatus.

### BRIEF DESCRIPTION OF DRAWINGS

The method, the UE and the network apparatus in a wireless network are illustrated in the accompanying drawings, throughout which like reference letters indicate corresponding parts in the various figures. The embodiments herein will be better understood from the following description with reference to the drawings, in which:

FIG. 1 is a sequence diagram illustrating a problem, according to the prior arts;

FIG. 2 illustrates an overview of a wireless network for handling unavailability of a UE, according to the embodiments as disclosed herein;

FIG. 3 illustrates various hardware components of the UE, according to the embodiments as disclosed herein;

FIG. 4 illustrates various hardware components of a network apparatus, according to the embodiments as disclosed herein;

FIG. 5 is a flow chart illustrating a method, implemented by the UE, for handling unavailability of the UE in the wireless network, according to the embodiments as disclosed herein;

FIG. 6 is a flow chart illustrating a method, implemented by the network apparatus, for handling unavailability of the UE in the wireless network, according to the embodiments as disclosed herein;

FIG. 7 is a sequence diagram illustrating a scenario of a proposed success case of a handling indication for acknowledgement, according to the embodiments as disclosed herein;

FIG. 8 is a sequence diagram illustrating a scenario of proposed failure case of a handling indication for acknowledgement, according to the embodiments as disclosed herein; and

FIG. 9 is another sequence diagram illustrating a scenario of a proposed failure case of a handling indication for acknowledgement, according to the embodiments as disclosed herein.

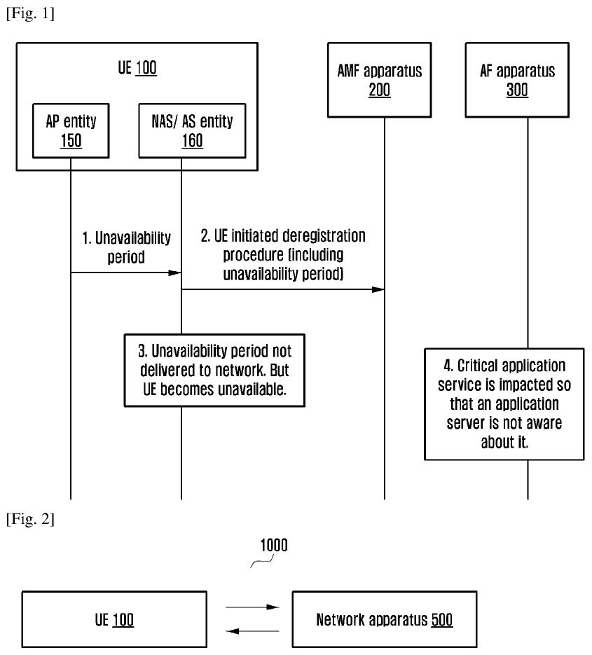

It may be noted that to the extent possible, like reference numerals have been used to represent like elements in the drawing. Further, those of ordinary skill in the art will appreciate that elements in the drawing are illustrated for simplicity and may not have been necessarily drawn to scale. For example, the dimension of some of the elements in the drawing may be exaggerated relative to other elements to help to improve the understanding of aspects of the invention. Furthermore, the one or more elements may have been represented in the drawing by conventional symbols, and the drawings may show only those specific details that are pertinent to the understanding the embodiments of the invention so as not to obscure the drawing with details that will be readily apparent to those of ordinary skill in the art having benefit of the description herein.

### MODE FOR THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

Accordingly, the embodiment herein is to provide a method for handling unavailability of a UE in a wireless network. The method includes detecting, by the UE, an unavailability event that makes the UE unavailable to a network apparatus. Further, the method includes determining, by the UE, an unavailability duration, where the unavailability duration is indicated as part of an unavailability period duration IE to the network apparatus. Further, the method includes sending, by the UE, a deregistration request message to the network apparatus by setting a deregistration type to a normal deregistration in response to determining that the deregistration request message comprises an unavailability Period duration IE. Further, the method includes determining by the UE, whether the unavailability duration sent by the UE in the deregistration request message is successfully set in the network apparatus.

In an embodiment, whenever an event is triggered in the UE which makes that the UE is unavailable, the UE sets unavailability period in a deregistration request message and even though the UE switches OFF due to the event (for example OS upgrades, binary updates etc needs UE to be switched off to complete the event), the UE does not indicate switch OFF cause in the deregistration request message, rather the UE sets a deregistration type to normal deregistration. The UE starts a timer T3521 and waits for the network apparatus to send a deregistration accept message. Once the deregistration accept message is received, the UE assumes that unavailability period is set successfully in the network apparatus/the AF apparatus. Further, the NAS entity in the UE indicates the same to upper layers (i.e., AP entity) about the same. Further, when the network apparatus receives the deregistration request message with deregistration type set to the normal deregistration, the network apparatus send the deregistration accept message to the UE.

In an embodiment, when the UE is not receiving the deregistration accept message and a T3521 timer expires at the UE, the UE re-attempts to send the deregistration request message with unavailability period, after 5 attempts (for example), the UE aborts deregistration procedure and indicates the same to the upper layer (i.e. AP (Application processor) entity). The upper layers selects to postpone executing the event because the unavailability period is not set at the network apparatus.

In an embodiment, when the network apparatus indicated support for the unavailability period in the last registration procedure, and an event is triggered in the UE that makes the UE unavailable for a certain period, the UE includes the Unavailability period duration IE, and sets the de-registration type to a “normal de-registration”, in the deregistration request message. The UE starts the timer T3521 and enters a 5GMM-deregistered-initiated state.

In an embodiment, when the deregistration request message is received by the network apparatus (e.g., AMF apparatus), the network apparatus sends a deregistration accept message to the UE, when the de-registration type IE does not indicate “switch off” (i.e. when de-registration type set to a “normal de-registration”).

Referring now to the drawings and more particularly to FIGS. 2 through 9, where similar reference characters denote corresponding features consistently throughout the figures, there are shown preferred embodiments.

FIG. 2 illustrates an overview of a wireless network (1000) for handling unavailability of a UE (100), according to the embodiments as disclosed herein. In an embodiment, the wireless network (1000) includes a UE (100) and a network apparatus (500). The wireless network (1000) can be, for example, but not limited to a fourth generation (4G) network, a fifth generation (5G) network, and an Open Radio Access Network (ORAN). The UE (100) can be, for example, but not limited to a laptop, a smart phone, a desktop computer, a notebook, a Device-to-Device (D2D) device, a vehicle to everything (V2X) device, a foldable phone, a smart TV, a tablet, an immersive device, and an internet of things (IoT) device. The network apparatus (500) can be, for example, but not limited to an AMF apparatus (200) and a Network Exposure Function (NEF) apparatus (400), Application Function (AF).

The UE (100) detects an unavailability event that makes the UE unavailable to the network apparatus (500). Based on the detection, the UE (100) determines an unavailability duration, where the unavailability duration is indicated as part of an unavailability period duration IE to the network apparatus (500). Further, the UE (100) sends the deregistration request message to the network apparatus (500) by setting a deregistration type to a normal deregistration in response to determining that the deregistration request message comprises the unavailability Period duration IE. Further, the UE (100) determines whether the unavailability duration sent by the UE (100) in the deregistration request message is successfully set in the network apparatus (500).

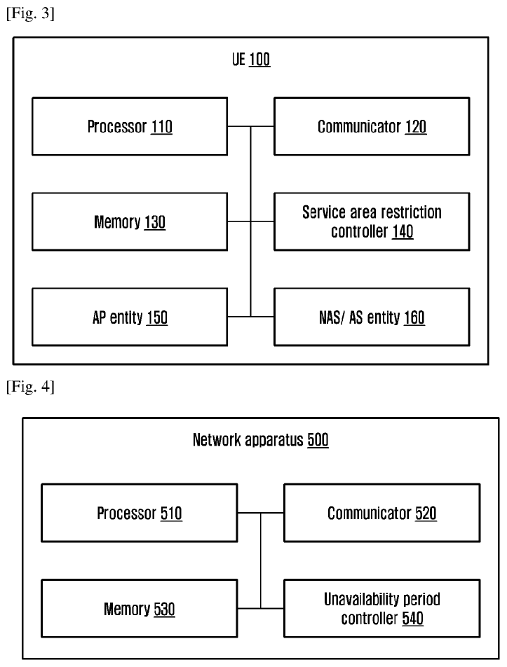

In an embodiment, the UE (100) initiates a timer to receive a deregistration accept message from the network apparatus (500) and enters the UE (100) into a deregistration initiated state, in response to sending the deregistration request message with the unavailability duration and setting a deregistration type to the normal deregistration. Further, the UE (100) receives the deregistration accept message from the network apparatus (500). Further, the UE (100) determines the unavailability period sent by the UE (100) in the deregistration request message is successfully set in the network apparatus, in response to receiving the deregistration accept message from the network apparatus, where a NAS entity or a AS entity (160) (as shown in FIG. 3) in the UE (100) indicates the determination to an application processor (AP) entity (150) in the UE (100).

Further, the UE (100) sends the deregistration request message for a predefined number of times after expiry of the timer to the network apparatus (500) when the deregistration accept message is not received from the network apparatus (500). Further, the UE (100) restarts the timer upon re-sending the deregistration request message to the network apparatus (500). Further, the UE (100) determines the unavailability period sent by the UE (100) in the deregistration request message is NOT successfully set in the network apparatus, in response to determining the deregistration accept message is NOT received from the network apparatus (500) after re-sending the deregistration request message to the network apparatus (500). Further, the UE (100) indicates from the NAS entity/AS entity (160) to the AP entity (150) upon determining that the deregistration accept message is not received from the network apparatus (500) after re-sending the deregistration request message for the predefined number of times to the network apparatus (500) or receiving a deregistration reject message from the network apparatus (500).

In an embodiment, the UE (100) determines whether the unavailability period sent by the UE (100) in the deregistration request message is successfully set in the network apparatus and performing one of the triggering the unavailability event to become unavailable in the wireless network (1000) when the UE determines the unavailability period sent by the UE (100) in the deregistration request message is successfully set in the network apparatus, and deferring the trigging of the unavailability event to become unavailable in the wireless network (1000) when the UE (100) determines sent unavailability period by the UE in the deregistration request message is NOT successfully set in the network apparatus (500). The defer for trigging the unavailability event means postpone the trigging of the unavailability event as the unavailability period is not set at the network apparatus (500).

FIG. 3 shows various hardware components of the UE (100), according to the embodiments as disclosed herein. In an embodiment, the UE (100) includes a processor (110), a communicator (120), a memory (130), a UE unavailability period controller (140), an AP entity (150) and a NAS/AS entity (160). The processor (110) is coupled with the communicator (120), the memory (130), the UE unavailability period controller (140), the AP entity and the NAS/AS entity (160).

The UE unavailability period controller (140) detects the unavailability event that makes the UE unavailable to the network apparatus (500). Based on the detection, the UE unavailability period controller (140) determines the unavailability duration, where the unavailability duration is indicated as part of the unavailability period duration IE to the network apparatus (500). Further, the UE unavailability period controller (140) sends the deregistration request message to the network apparatus (500) by setting the deregistration type to the normal deregistration in response to determining that the deregistration request message comprises the unavailability Period duration IE. Further, the UE unavailability period controller (140) determines whether the unavailability duration sent by the UE (100) in the deregistration request message is successfully set in the network apparatus (500).

In an embodiment, the UE unavailability period controller (140) initiates the timer to receive the deregistration accept message from the network apparatus (500) and enters the UE (100) into the deregistration initiated state, in response to sending the deregistration request message with the unavailability duration and setting a deregistration type to the normal deregistration. Further, the UE unavailability period controller (140) receives the deregistration accept message from the network apparatus (500). Further, the UE unavailability period controller (140) determines the unavailability period sent by the UE (100) in the deregistration request message is successfully set in the network apparatus, in response to receiving the deregistration accept message from the network apparatus, where the NAS entity or the AS entity (160) in the UE (100) indicates the determination to the application processor (AP) entity (150) in the UE (100) to indicate to the applications.

Further, the UE unavailability period controller (140) sends the deregistration request message for a predefined number of times after expiry of the timer to the network apparatus (500) when the deregistration accept message is not received from the network apparatus (500). Further, the UE unavailability period controller (140) restarts the timer upon re-sending the deregistration request message to the network apparatus (500). Further, the UE unavailability period controller (140) determines the unavailability period sent by the UE (100) in the deregistration request message is NOT successfully set in the network apparatus, in response to determining, by the UE (100), the deregistration accept message is NOT received from the network apparatus (500) after re-sending the deregistration request message to the network apparatus (500). Further, the UE unavailability period controller (140) indicates from the NAS entity/AS entity (160) to the AP entity (150) upon determining that the deregistration accept message is not received from the network apparatus (500) after re-sending the deregistration request message for the predefined number of times to the network apparatus (500) or receiving a deregistration reject message from the network apparatus (500).

In an embodiment, the UE unavailability period controller (140) determines whether the unavailability period sent by the UE (100) in the deregistration request message is successfully set in the network apparatus and performing one of triggering the unavailability event to become unavailable in the wireless network (1000) when the UE determines the unavailability period sent by the UE (100) in the deregistration request message is successfully set in the network apparatus, and deferring the trigging of the unavailability event to become unavailable in the wireless network (1000) when the UE (100) determines sent unavailability period by the UE in the deregistration request message is NOT successfully set in the network apparatus (500).

The UE unavailability period controller (140) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (110) is configured to execute instructions stored in the memory (130) and to perform various processes. The communicator (120) is configured for communicating internally between internal hardware components and with external devices via one or more networks. The memory (130) also stores instructions to be executed by the processor (110). The memory (130) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (130) may, in some examples, be considered a non-transitory storage medium. The term “non-transitory” may indicate that the storage medium is not embodied in a carrier wave or a propagated signal. The term “non-transitory” should not be interpreted that the memory (130) is non-movable. In certain examples, a non-transitory storage medium may store data that can, over time, change (e.g., in Random Access Memory (RAM) or cache).

Although the FIG. 3 shows various hardware components of the UE (100) but it is to be understood that other embodiments are not limited thereon. In other embodiments, the UE (100) may include less or more number of components. Further, the labels or names of the components are used only for illustrative purpose and does not limit the scope of the invention. One or more components can be combined together to perform same or substantially similar function in the UE (100).

FIG. 4 shows various hardware components of the network apparatus (500), according to the embodiments as disclosed herein. In an embodiment, the network apparatus (500) includes a processor (510), a communicator (520), a memory (530) and a UE unavailability period controller (540). The processor (510) is coupled with the communicator (520), the memory (530) and the UE unavailability period controller (540).

The UE unavailability period controller (540) receives the deregistration request message from the UE (100), where the deregistration request message includes an unavailability period duration information element and the deregistration type is set to normal deregistration. Further, the UE unavailability period controller (540) stores the unavailability period duration information element of the UE (100) and the deregistration type set to the normal deregistration. Further, the UE unavailability period controller (540) sends one of the deregistration accept message and the deregistration reject message based on the deregistration type.

The UE unavailability period controller (540) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (510) is configured to execute instructions stored in the memory (530) and to perform various processes. The communicator (520) is configured for communicating internally between internal hardware components and with external devices via one or more networks. The memory (530) also stores instructions to be executed by the processor (510). The memory (530) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (530) may, in some examples, be considered a non-transitory storage medium. The term “non-transitory” may indicate that the storage medium is not embodied in a carrier wave or a propagated signal. The term “non-transitory” should not be interpreted that the memory (530) is non-movable. In certain examples, a non-transitory storage medium may store data that can, over time, change (e.g., in Random Access Memory (RAM) or cache).

Although the FIG. 4 shows various hardware components of the network apparatus (500) but it is to be understood that other embodiments are not limited thereon. In other embodiments, the network apparatus (500) may include less or more number of components. Further, the labels or names of the components are used only for illustrative purpose and does not limit the scope of the invention. One or more components can be combined together to perform same or substantially similar function in the network apparatus (500).

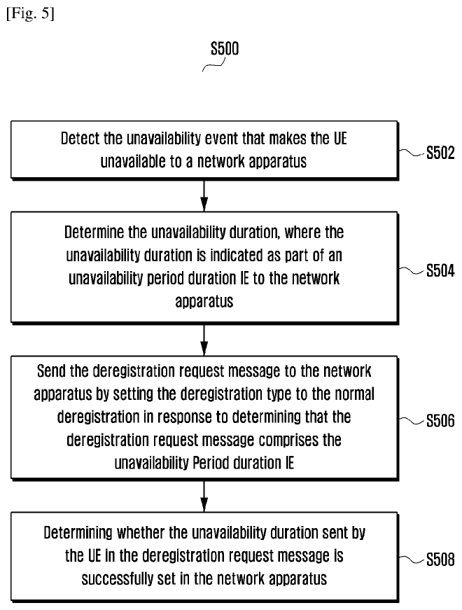

FIG. 5 is a flow chart (S500) illustrating a method, implemented by the UE (100), for handling unavailability of the UE (100) in the wireless network (1000), according to the embodiments as disclosed herein. The operations (S502-S508) are handled by the UE unavailability period controller (540).

At step S502, the method includes detecting the unavailability event that makes the UE unavailable to a network apparatus (500). At step S504, the method includes determining the unavailability duration, where the unavailability duration is indicated as part of an unavailability period duration IE to the network apparatus (500). At step S506, the method includes sending the deregistration request message to the network apparatus (500) by setting the deregistration type to the normal deregistration in response to determining that the deregistration request message comprises the unavailability Period duration IE. At step S508, the method includes determining whether the unavailability duration sent by the UE (100) in the deregistration request message is successfully set in the network apparatus (500).

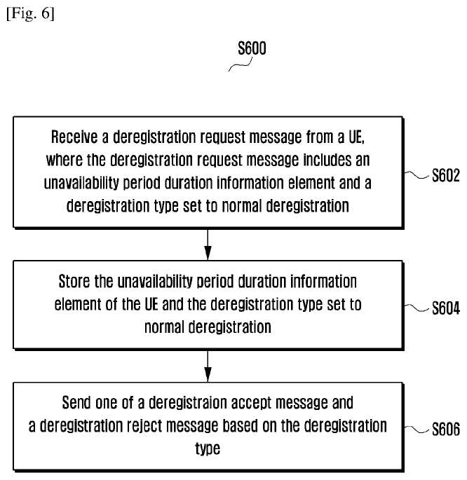

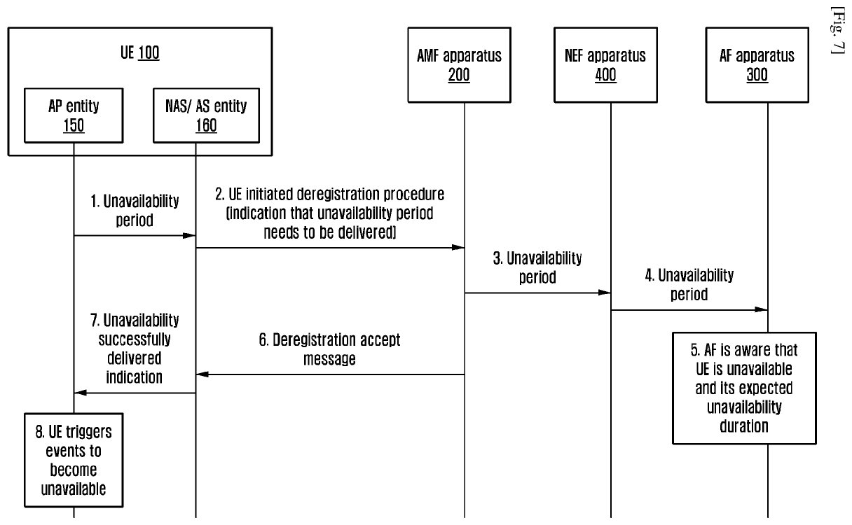

FIG. 6 is a flow chart (S600) illustrating a method, implemented by the network apparatus (500), for handling unavailability of the UE (100) in the wireless network (1000), according to the embodiments as disclosed herein. The operations (S602-S606) are handled by the UE unavailability period controller (540).

At step S602, the method includes receiving the deregistration request message from the UE (100), where the deregistration request message includes the unavailability period duration information element and the deregistration type set to the normal deregistration. At step S604, the method includes storing the unavailability period duration information element of the UE (100) and the deregistration type set to the normal deregistration. At step S606, the method includes sending one of the deregistration accept message and the deregistration reject message based on the deregistration type.

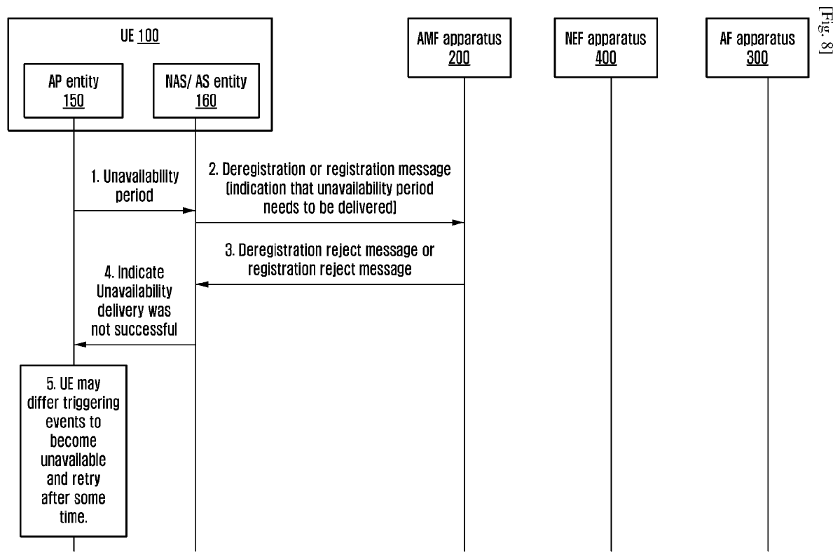

FIG. 7 is a sequence diagram illustrating a scenario of proposed success case of the handling indication for acknowledgement, according to the embodiments as disclosed herein. Consider in this case, the network apparatus (500) is the AMF apparatus (200) and the NEF apparatus (400) or application function (AF) apparatus.

Referring to FIG. 7, when the UE (100) indicates the unavailability period in the deregistration request message or the registration request message or any other NAS message, the UE (100) includes with one or any combination of below information elements:
a) The de-registration type “normal de-registration”,
b) The de-registration type “switch OFF” and also include the “unavailability period”,
c) Any new indication in the deregistration request message or registration request message or any other NAS message,
d) Include the “unavailability period”,
e) The indication helps an AMF apparatus (200) to understand the message is sent to deliver “unavailability period” to a 5GC and/or to the AF apparatus (300).

The UE (100) starts the timer T3521 waiting for acknowledgement from the AMF apparatus (200) i.e. the deregistration accept message or any other NAS message when the deregistration request message is sent. Otherwise, the UE (100) starts the T3510 timer or the T3511 timer (for example) when the registration request message is sent.

When the AMF apparatus (200) receives the deregistration request message or any other NAS message with one or any combination of below information elements:
a) The de-registration type “normal de-registration”; or
b) The de-registration type “switch OFF” and also include the “unavailability period”; or
c) “Unavailability period”

The AMF apparatus (200) sends the deregistration accept message. When the AMF apparatus (200) receives or determines that the AMF apparatus (200) has received unavailability period in any NAS message like registration request or deregistration request message, the AMF apparatus (200) sends the response NAS message like registration accept or the deregistration accept message to the UE (100).

In yet another embodiment, the AMF apparatus (200) sends the indication to the UE (100) by sending the response NAS message like registration accept or deregistration accept to indicate successful reception of the unavailability period. In yet another embodiment, the AMF apparatus (200) sends the indication to the UE (100) in response to the NAS message like registration accept or deregistration accept to indicate at least one of the successful reception of the unavailability period and successful deliver of unavailability period to the AF apparatus (300) via the NEF apparatus (400).

The NAS/AS entity (160) in the UE (100) indicates that unavailability period indication to the AMF apparatus (200) and application function is successful to the upper layers, when the UE (100) receives the
1. Response NAS message like registration accept or the deregistration accept message; or
2. Indication to the UE (100) in response NAS message like registration accept or the deregistration accept to indicate successful reception of the unavailability period; or
3. Indication to the UE (100) in response NAS message like registration accept or deregistration accept to indicate successful reception of the unavailability period and/or successful deliver of unavailability period to the AF apparatus (300) via the NEF apparatus (400).

When the AMF apparatus (200) received unavailability period in the NAS message and there is “Loss of Connectivity” event subscription for the UE (100), the AMF apparatus (200) includes unavailability period in an event notification report.

In yet another embodiment, when the UE (100) sets de-registration type to switch OFF and does not include unavailability period, the AMF (200) does not send deregistration accept message to the UE (100).

Referring to FIG. 7, At step 1, the AP entity (150) in the UE (100) sends the unavailability period to the NAS/AS entity (160) in the UE (100). At step 2, the NAS/AS entity (160) in the UE (100) initiates the deregistration procedure including the unavailability period to indicate to the AMF apparatus (200). At step 3, the AMF apparatus (200) sends the unavailability period to the NEF apparatus (400). At step 4, the NEF apparatus (400) sends the unavailability period to the AF apparatus (300). At step 5, the AF apparatus (300) is aware that the UE (100) is unavailable and the UE's (100) expected unavailability duration i.e. unavailability duration determined by the UE (100). At step 6, the AMF apparatus (200) sends the deregistration accept message to the NAS/AS entity (160) in the UE (100). At step 7, the NAS/AS entity (160) in the UE (100) indicates unavailability successfully delivered indication to the AP entity (150) in the UE (100). At step 8, the UE (100) triggers events to become unavailable.

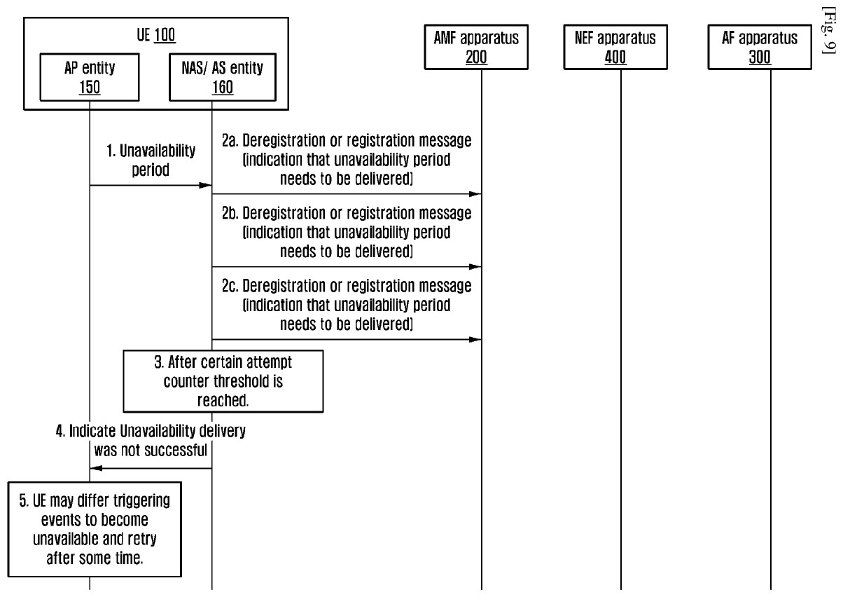

FIG. 8 is a sequence diagram illustrating a scenario of proposed failure case of the handling indication for the acknowledgement, according to the embodiments as disclosed herein. Consider in this case, the network apparatus (500) is the AMF apparatus (200) and the NEF apparatus (400) and the AF apparatus.

Referring to the FIG. 8, when the UE (100) does not receive the deregistration accept message, until the first four expiries of the timer, the UE (100) retransmit the deregistration request message and resets and restarts the timer T3521. On the fifth expiry of timer T3521, the de-registration procedure is aborted and the NAS/AS entity (160) of the UE (100) indicates that unavailability period updating to the AMF apparatus (200) and the application function is not successful to the upper layers.

When the UE (100) receives the deregistration reject message, registration reject message or the UE (100) determines that the UE (100) cannot send the deregistration request message or the registration request message to the AMF apparatus (200) due to, for example, but is not limited to:
1. Lower layer failure or release of the N1 NAS signalling connection before reception of response NAS message like deregistration accept message or registration accept message.
2. The lower layers indicate that the access attempt is barred.
3. Transmission failure of deregistration request or registration request message.

Then the NAS/AS entity (160) of the UE (100) indicates that the unavailability period updating to the AMF apparatus (200) and the application function is not successful to the upper layers.

In yet another embodiment, the UE (100) can indicate to the upper layers after multiple retries and attempt counter of the respective NAS procedure reaches certain threshold such as 4, 5, 6, etc. The UE (100) differs triggering events to become unavailable and retries after some time.

In summary, when the UE (100) fails to successfully execute the procedure which is initiated to update the unavailability period to the AMF apparatus (200) and/or application function for e.g. NAS response is reject message for e.g. Deregistration reject message or registration reject or service reject message is received for any of the causes as described in 3GPP TS 24.501 or sending of the NAS message like registration request, service request or deregistration request carrying unavailability period is not successful due to any of the abnormal cases as described in TS 24.501 then the NAS/AS entity (160) of the UE (100) indicates that unavailability period updating to the AMF apparatus (200) and application function is not successful to the upper layers.

When the UE (100) receives the response NAS message like deregistration accept message or registration accept, the NAS/AS entity (160) of the UE (100) indicates that the unavailability period updating (informing or indicating) to the AMF apparatus (200) and the application function is successful to the upper layers. In an embodiment, the upper layers are the application layer in the UE (100) i.e. indication is to one or more applications in the UE (100).

In an embodiment, the registration request, registration accept, deregistration request, deregistration accept messages are only indicative and the message can be any new or existing NAS message as described in 3GPP TS 24.501.

As shown in the FIG. 8, at step 1, the AP entity (150) in the UE (100) sends the unavailability period to the NAS/AS entity (160) in the UE (100). At step 2, the NAS/AS entity (160 in the UE (100) sends the deregistration message or the registration message to the AMF apparatus (200). The deregistration message or the registration message indicates that unavailability period needs to be delivered to the AMF apparatus (200). At step 3, the AMF apparatus (200) sends the deregistration reject message or the registration reject message to the NAS/AS entity (160) in the UE (100). The NAS/AS entity (160) in the UE (100) indicates that unavailability delivery is not successful to the AP entity (150) in the UE (100). At step 4, the UE (100) differs the triggering events to become unavailable and retry after some time.

FIG. 9 is another sequence diagram illustrating a scenario of the proposed failure case of the handling indication for acknowledgement, according to the embodiments as disclosed herein. Consider in this case, the network apparatus (500) is the AMF apparatus (200) and the NEF apparatus (400)/AF apparatus.

Referring to the FIG. 9, the patent disclosures discloses about the UE (100) determines that delivery/sending/indication of unavailability period is not successful. Whenever the UE (100) determines that delivery/sending/indication of unavailability period is not successful then the UE (100) remains in a registered state. In an example, the UE (100) sends the deregistration message including the unavailability period, but in the response NAS message, the UE (100) determines that delivery/sending/indication of the unavailability period is not successful so that the UE (100) can enter again 5GMM_REGISTERED state. Hence, the UE (100) can attempt to send the unavailability period again after some time and differs the execution of the events which can trigger the UE (100) to become unavailable. Further, the UE (100) can continue to send or receive data as the UE (100) is in the 5GMM_REGISTERED.

The terms unavailability duration or unavailability period or unavailability configuration data or unavailability period duration IE are used interchangeably.

The “unavailability configuration data” or unavailability duration or unavailability period or unavailability period duration IE is at least one of the following:
a) UE's allowed “unavailability time” like time of the day, day of the week, day of the month or any other date. The unavailability time can also be represented in the form of Start time and End time.
b) How long the UE (100) is allowed to remain or is unavailable. Duration in minutes or seconds or hours.
c) Geographical area in which the UE (100) is allowed to be unavailable.
d) Geographical area in which the UE (100) is not allowed to be unavailable.
e) A timer value can be provided. For example, Active timer at expiry of which the UE (100) is allowed to become unavailable.

As shown in the FIG. 9, at step 1, the AP entity (150) in the UE (100) sends the unavailability period to the NAS/AS entity (160) in the UE (100). At steps 2a-2c, the NAS/AS entity (160) in the UE (100) sends the deregistration message or the registration message to the AMF apparatus (200). The deregistration message or the registration message indicates that unavailability period needs to be delivered to the AMF apparatus (200) for example by including the unavailability period duration IE. At step 3, after certain attempts of step 2, the counter threshold is reached. The UE determines that unavailability period indication to the AMF is not successful. The NAS/AS entity (160) in the UE (100) indicates that unavailability Period delivery or indication is not successful to the AP entity (150) in the UE (100). At step 5, the UE (100) differs the triggering events to become unavailable and retry after some time.

The various actions, acts, blocks, steps, or the like in the flow charts (S500 and S600) may be performed in the order presented, in a different order or simultaneously. Further, in some embodiments, some of the actions, acts, blocks, steps, or the like may be omitted, added, modified, skipped, or the like without departing from the scope of the invention.

Whenever the event is triggered in the UE (100) which makes that the UE (100) is unavailable, the UE (100) sets unavailability period in the deregistration request message and even though the UE switches OFF due to the event, the UE does not indicate a switch off cause in the deregistration request message, rather the UE sets a deregistration type to a normal deregistration (i.e. not switch off type). The UE starts a timer T3521 and waits for the network apparatus (500) to send the deregistration accept message. Once the deregistration accept message is received, the UE (100) assumes that an unavailability period is set successfully in the network apparatus (500)/AF apparatus (300). Further, the NAS/AS entity (160) in the UE (100) indicates the same to upper layers (i.e., AP entity (150)) about the same. Further, when the network apparatus (500) receives the deregistration request message with the deregistration type set to the normal deregistration, the network apparatus (500) sends the deregistration accept message to the UE (100).

When the UE (100) is not receiving the deregistration accept message (i.e. there is no response message) and a T3521 timer expires at the UE (100), the UE (100) re-attempts to send the deregistration request message with unavailability period, and after 5 attempts (for example), the UE (100) aborts the deregistration procedure and indicates the same to the upper layer (i.e. AP entity about failure to indicate unavailability period to AMF/NEF/AF). The upper layers selects to postpone executing the event because the unavailability period is not set at the network apparatus (500). Thus, results in saving the resource between the UE (100) and the network apparatus (500) and at the same time, the UE (100) and the network apparatus function (e.g. Application function apparatus) will be in sync and the UE (100) will not become unavailable without informing AF, thus there are no impacts to AF.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

1. A method performed by a user equipment (UE) in a wireless network, the method comprising:
detecting an unavailability event that makes the UE unavailable to a network apparatus for a period;
determining an unavailability duration indicating a length of the period;
transmitting a deregistration request message to the network apparatus, wherein information on the unavailability duration is included in the deregistration request message and a deregistration type is set to a normal deregistration in the deregistration request message; and
initiating a timer to receive a deregistration accept message from the network apparatus.

2. The method of claim 1, further comprising:
receiving, from the network apparatus, the deregistration accept message; and
identifying that the deregistration request message is successfully set in the network apparatus based on the deregistration accept message.

3. The method of claim 1, further comprising:
transmitting, to the network apparatus, the deregistration request message after expiry of the timer in case that the deregistration accept message is not received from the network apparatus; and
restarting the timer upon transmitting the deregistration request message to the network apparatus after expiry of the timer;
wherein a deregistration procedure is aborted in case that the timer expires for a predefined number of times.

4. The method of claim 1,
wherein an non-access stratum (NAS) entity or an access stratum (AS) entity in the UE indicates the result of a deregistration process to an application protocol (AP) entity in the UE.

5. The method of claim 1, further comprising:
postponing a triggering of the unavailability event in case that a deregistration accept message is not received from the network apparatus.

6. A method performed by a network apparatus in a wireless network, the method comprising:
receiving, from a user equipment (UE), a deregistration request message including information on an unavailability period duration and a deregistration type set to a normal deregistration; and
transmitting, to the UE, one of a deregistration accept message or a deregistration reject message based on the deregistration type.

7. A user equipment in a wireless network, the UE comprising:
a memory;
a processor; and
a controller, communicatively coupled to the memory and the processor, configured to:
detect an unavailability event that makes the UE unavailable to a network apparatus for a period,
determine an unavailability duration indicating a length of the period, transmit a deregistration request message to the network apparatus,
wherein information on the unavailability duration is included in the deregistration request message and a deregistration type is set to a normal deregistration in the deregistration message, and
initiate a timer to receive a deregistration accept message from the network apparatus.

8. The UE of claim 7,
wherein the controller is further configured to:
receive, from the network apparatus, the deregistration accept message, and
identify that the deregistration request message is successfully set in the network apparatus based on the deregistration accept message.

9. The UE of claim 7,
wherein the controller is further configured to:
transmit, to the network apparatus, the deregistration request message after expiry of the timer in case that the deregistration accept message is not received from the network apparatus, and
restart the timer upon transmitting the deregistration request message to the network apparatus after expiry of the timer,
wherein a deregistration procedure is aborted in case that the timer expires for a predefined number of times.

10. The UE of claim 7,
wherein an non-access stratum (NAS) entity or an access stratum (AS) entity in the UE indicates the result of a deregistration process to an application protocol (AP) entity in the UE.

11. The UE of claim 7,
wherein the controller is further configured to:
postpone a triggering of the unavailability event in case that a deregistration accept message is not received from the network apparatus.

12. A network apparatus in a wireless network, the network apparatus comprising:
a memory;
a processor; and
a controller, communicatively coupled to the memory and the processor, configured to:
receive, from a user equipment (UE), a deregistration request message including information on an unavailability period duration and a deregistration type set to a normal deregistration, and
transmit one of a deregistration accept message or a deregistration reject message based on the deregistration type.
